(19) United States
(12) Patent Application Publication
(10) Pub. No.: US 2013/0136807 A1
(43) Pub. Date: May 30, 2013

(54) INSECT PROOF AND INSECTICIDAL COMPOSITION FOR THE CONSERVATION OF CULTURAL PROPERTY COMPRISING Asarum sieboldii EXTRACT OR A FRACTION THEREOF AS AN ACTIVE INGREDIENT

(71) Applicants: Chang Wook JO, Daejeon (KR); Young Hee KIM, Daejeon (KR); Jin Young HONG, Daejeon (KR); Mi Hwa JUNG, Daejeon (KR); Soo Ji KIM, Daejeon (KR); Jeung-Min LEE, Kimhae-si (KR); Jung Eun CHOI, Daejeon (KR); So Young JEONG, Daejeon (KR)

(72) Inventors: Chang Wook JO, Daejeon (KR); Young Hee KIM, Daejeon (KR); Jin Young HONG, Daejeon (KR); Mi Hwa JUNG, Daejeon (KR); Soo Ji KIM, Daejeon (KR); Jeung-Min LEE, Kimhae-si (KR); Jung Eun CHOI, Daejeon (KR); So Young JEONG, Daejeon (KR)

(73) Assignee: NATIONAL RESEARCH INSTITUTE OF CULTURAL HERITAGE, Daejeon (KR)

(21) Appl. No.: 13/450,969

(22) Filed: Apr. 19, 2012

(30) Foreign Application Priority Data
Nov. 28, 2011 (KR) 10-2011-0125016

(51) Int. Cl. A01N 65/08; A01P 7/04

(52) U.S. Cl. 424/725

(57) ABSTRACT

Disclosed herein is an insect proof or insecticidal composition for the conservation of cultural properties against termites, comprising an extract of Asarum sieboldii as an active ingredient. Based on a methanol extract of Asarum sieboldii or a hexane fraction from the methanol extract, the composition is environmentally friendly and non-toxic to humans and animals. Also, because of its excellent insecticidal activity against termites, the composition can be used to protect wooden structures and cultural properties from termite damage, which is a great threat to the life of wooden structures and cultural properties, without toxicity to humans and animals.

### CROSS-REFERENCES TO RELATED APPLICATION

This patent application claims the benefit of priority from Korean Patent Application No. 10-2011-0125016, filed on Nov. 28, 2011, the entire contents of which are incorporated herein by reference.

### BACKGROUND OF THE INVENTION

1. Field of the Invention

The present invention provides an insect proof or insecticidal composition against termites, comprising an extract of Asarum sieboldii or a fraction thereof as an active ingredient.

2. Description of the Related Art

In cultural properties, various materials are found. Representative among them are metals, stone, wood, paper, and fibers. With the passage of time, cultural properties experience damage to different extents according to storage conditions, so that their lives are shortened. Most cultural properties, although retaining their original forms, have been weathered by natural and environmental factors including rain, wind, and sunlight, and artificially damaged by administrators and galleries. Higher care must be taken in conserving cultural properties made of organic materials such as paper, fiber, and wood than for those made of inorganic materials because of their susceptibility to biological damage by insects and microbes.

Inter alia, insect damage is most serious because insects use the organic materials of cultural properties as food, while encroaching on cultural properties themselves. In addition, insect damage frequently occurs to cultural properties. Thus, the control of insects is one of the most important factors that should be considered in conserving and managing cultural properties.

Typical examples of the insects harmful to cultural properties made of wood, paper, or fibers include Isoptera, Coleoptera, Thysanura, Blattaria, Hymenoptera, and Psocoptera, with the greatest damage caused by Isoptera and Coleoptera.

Reticulitermes speratus is a group of eusocial insects and live in colonies with a hierarchal society dominated by an egg-laying queen. These insects settle down at one place for 30 years, causing damage to humans. Damage caused by these insects has been reported everywhere around the world, and has occurred on various structures such as timbers, wooden furniture, houses, telegraph poles, bridges and crossties, and even on crops. In Korea, some natural treasures stored in a famous temple have suffered damage from the insect.

Asarum sieboldii is a perennial plant belonging to the Aristolochiaceae family. Roots of Asarum heterotropoides F. Maekawa var. mandshuricum F. Maekawa or Asarum sieboldii var. seoulensis are used as medicinal substances in herbal medicines. From Asarum sieboldii, various ingredients including methyleugenol, cineol, limonene (estragole), eucarvon e (azulene), elemicin, kakuol, γ-asarone, and asarylketone have been separated. Extracts from Asarum sieboldii are reported to exhibit antipyretic, sedative, analgesic, anti-inflammatory, and anti-bacterial activities.

In order to prevent or maximally defend against insect damage to cultural properties, the following measures must be taken. First, periodic examination must be made of cultural properties. In addition, when insect damage is found, the insects must be identified on the basis of data about the physiology, habits, and ecology of the insects. Finally, a method that is selected depending on the identity of the insects so as to control them without incurring damage to the cultural properties is implemented.

Methyl bromide is a pesticide that had been extensively used worldwide until its production and use were curtailed by international protocol due to its ecological toxicity. Because it was phased out, there has been a need for alternatives to methyl bromide. Since then, extensive efforts have been made to find alternatives that are non-toxic to humans and animals and are friendly to the environment as well as exhibiting high insecticidal activity.

Various herbal compositions are disclosed as insect-controlling agents, including a composition characterized by an Acorus tatarinowii Schott extract in Korean Patent Application No. 10-2001-0026179, a mixture comprising sulfur, sericite, and fermented black garlic in Korean Patent Application No. 10-2007-0033344, and a composition comprising cyanosulfoximine in Korean Patent Application No. 10-2010-7013146. However, nowhere is the insect proofing or insecticidal activity of an Asarum sieboldii extract disclosed in previous documents.

Leading to the present invention, intensive and thorough research into the protection of cultural properties from termites, conducted by the present inventors, resulted in the finding that an extract from Asarum sieboldii extract or a fraction thereof has excellent insecticidal activity against termites.

### SUMMARY OF THE INVENTION

It is an object of the present invention to provide an insect proofing or insecticidal composition against Reticulitermes speratus, comprising an extract from Asarum sieboldii or a fraction thereof as an active ingredient.

It is another object of the present invention to provide a method for conserving cultural properties, comprising treating culturing properties with the composition of the present invention by direct spraying, coating, fumigation, aroma pervasion, or packaging.

In accordance with an aspect thereof, the present invention provides an insect proof or insecticidal composition against termites, comprising an extract of Asarum sieboldii as an active ingredient.

In accordance with another aspect thereof, the present invention provides an insect proof or insecticidal composition against termites, comprising an organic solvent fraction from an extract of Asarum sieboldii as an active ingredient.

In accordance with a further aspect thereof, the present invention provides a method for conserving cultural properties, comprising treating the cultural properties with the composition of the present invention by direct spraying, coating, fumigation, aroma pervasion or packaging.

Having excellent insecticidal activity against termites and being environmentally friendly, the extract of Asarum sieboldii or an organic fraction thereof in accordance with the present invention can be used to protect wooden structures and cultural properties from termite damage, which is a great threat to the life of wooden structures and cultural properties, without toxicity to humans and animals

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a graph showing the mortality of termites when a methanol extract of Asarum sieboldii is applied to the termites;

FIG. 2 is a graph showing the mortality of termites when a hexane fraction obtained from the methanol extract is applied to the termites;

FIG. 3 is a graph showing the mortality of termites when a methylene chloride fraction of Asarum sieboldii obtained from the hexane fraction is applied to the termites;

FIG. 4 is a graph showing the mortality of termites when an ethyl acetate fraction of Asarum sieboldii is applied to the termites;

FIG. 5 is a graph showing the mortality of termites when a methylene chloride fraction obtained from the methanol extract is applied to the termites;

FIG. 6 is a graph showing a weight change in male rats orally administered with an extract of Asarum sieboldii; and

FIG. 7 is a graph showing a weight change in female rats orally administered with an extract of Asarum sieboldii.

### DESCRIPTION OF THE PREFERRED EMBODIMENTS

Below, a detailed description will be given of the present invention.

In accordance with an aspect thereof, the present invention addresses an insect proofing or insecticidal composition against termites, comprising an extract of Asarum sieboldii as an active ingredient.

The extract of Asarum sieboldii may be preferably prepared using a method comprising, but not limited to, the following steps:

1) adding an extraction solvent to Asarum sieboldii to give an extract;

2) filtering the extract of step 1); and

3) concentrating the filtrate of step 2) under a high pressure and drying the concentrate.

In this method, any Asarum sieboldii, whether cultured or purchased, may be used.

The parts of Asarum sieboldii that are useful in the present invention are preferably leaves, stems, and roots, more preferably stems and roots, and most preferably roots.

As the extraction solvent, water, alcohol, or a mixture thereof may be preferably used. The alcohol may be a C₁ or C₂ lower alcohol, that is, methanol or ethanol. The extraction may be conducted using a shaking extraction method, a Soxhlet extraction method, or a reflux extraction method. The extraction solvent is used in a volume of ten times as much as dried Asarum sieboldii. The extraction temperature may be preferably set within the range of from 30 to 100° C. Extraction is preferably continued for 10 to 48 hours, and more preferably for 15 to 30 hours. Also, the extraction may be preferably repeated three to five times, more preferably three times.

In step 3 of the method, the filtrate may be concentrated using, but not limited to, a centrifugal vacuum concentrator, a vacuum concentrator, or a rotary vacuum evaporator. The concentrate may be dried using a vacuum drying method, a reduced-pressure drying method, a boiling drying method, a spray drying method, or a freeze drying method.

Examples of the termites preferably include insects belonging to Mastotermitidae, Termopsidae, Kalotermitidae, Hodetermitidae, Rhinotermitidae, and Termitidae, with preference for Rhinotermitidae. Reticultitermes speratus and R. speratus kyushuensis Morimoto are more preferable, with the former being preferred to the latter.

Also, contemplated in accordance with another aspect of the present invention is an insect proofing or insecticidal composition against termites, comprising an organic fraction of an Asarum sieboldii extract as an active ingredient.

The fraction of Asarum sieboldii extract may be preferably prepared using a method comprising, but not limited to, the following steps:

1) adding an extraction solvent to Asarum sieboldii to give an extract;

2) cooling and filtering the extract of step 1);

3) concentrating the filtrate of step 2) under a high pressure and drying the concentrate; and

4) fractionating the dried concentrate of step 3) with an organic solvent.

In this method, any Asarum sieboldii, whether cultured or purchased, may be used.

The organic solvent useful in step 4) may preferably be n-hexane, dichloromethane, or ethyl acetate, with preference for ethyl acetate.

In one preferable embodiment, a methanol extract of Asarum sieboldii is suspended in distilled water and mixed with an equal volume of n-hexane, followed by fractionation using a separatory funnel to remove the hexane layer. The remaining aqueous layer is fractionated with an equal volume of ethyl acetate and the ethyl acetate layer is separated and concentrated, followed by freeze drying to obtain an ethyl acetate fraction.

Also, fractionation from the Asarum sieboldii extract may be preferably repeated one to five times, more preferably three times. Preferably, the fraction may be concentrated in a vacuum.

In one preferred embodiment, a methanol extract of Asarum sieboldii, and a hexane fraction, a methylene chloride fraction, and an ethyl acetate fraction of Asarum sieboldii are prepared.

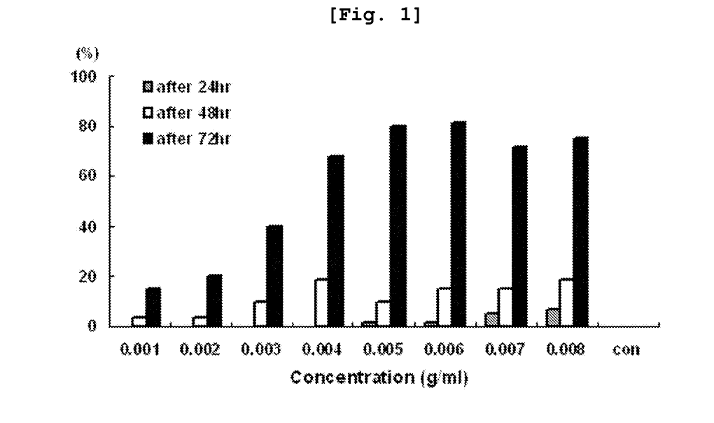

In one concrete embodiment of the present invention, the methanol extract of Asarum sieboldii was tested for insecticidal activity against termites. The insecticidal activity was slight until 24 and 48 hours after application, but rapidly increased 72 hours after application. Mortality was 68.3% at a concentration of 0.004 g/ml, and increased to up to 80% at higher concentrations. In addition, the remaining individuals, although alive, were so knocked out that they could not undertake activity. Thus, the methanol extract has excellent insecticidal activity against termites (FIG. 1).

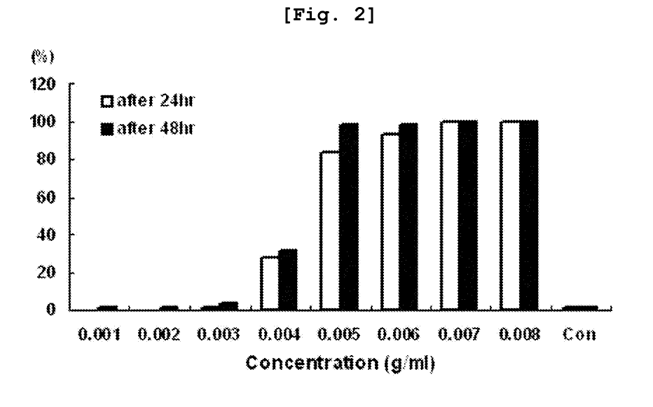

In another concrete embodiment of the present invention, the hexane fraction of Asarum sieboldii was tested for insecticidal activity against termites. As a result, the hexane fraction of Asarum sieboldii was found to exhibit excellent insecticidal activity from 24 hours after application at high concentrations. The mortality was over 80% even at a concentration of 0.005 g/ml. The mortality approximated 100% 48 hours after application. At a concentration of 0.004 g/ml, however, the mortality was rapidly decreased to 40% or less. Thus, the insecticidal fraction was set to have a concentration between 0.004 g/ml and 0.005 g/ml (FIG. 2).

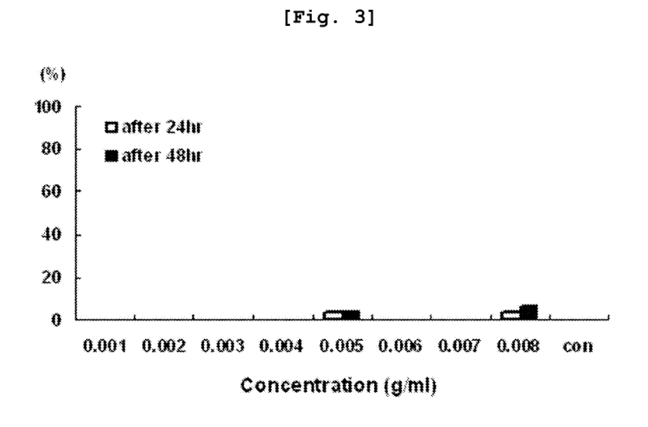

In a further concrete embodiment of the present invention, a methylene fraction of Asarum sieboldii and an ethyl acetate fraction of Asarum sieboldii were also tested for insecticidal activity against termites. Little insecticidal effects could be obtained at all concentrations, indicating that principal insecticidal substances of Asarum sieboldii were fractionated in the hexane layer (FIGS. 3 to 5).

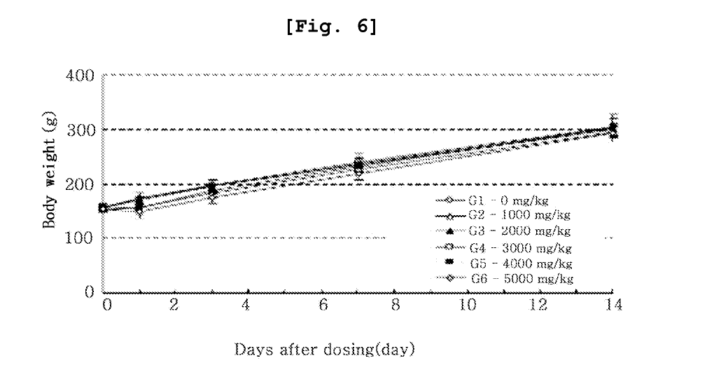

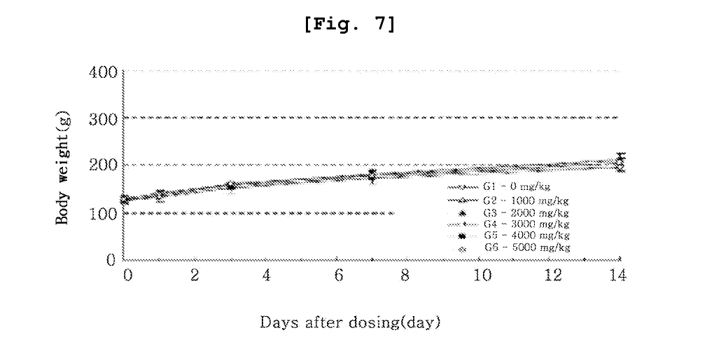

Also, the extract of Asarum sieboldii was analyzed for toxicity in vivo. In this regard, the extract of Asarum sieboldii was orally administered to animals which were then monitored for general symptom and weight change and subjected to autopsy. These examinations demonstrated that the extract of Asarum sieboldii is so safe that it can be orally administered (FIGS. 6 and 7).

Because of its excellent insecticidal activity against termites and being environmentally friendly, the extract of Asarum sieboldii or an organic fraction thereof in accordance with the present invention can be used to protect wooden structures and cultural properties from termite damage, which is a great threat to the life of wooden structures and cultural properties, without toxicity to humans and animals.

In accordance with a further aspect thereof, the present invention addresses a method for preserving cultural properties, comprising treating the cultural properties with the composition of the present invention by direct spraying, coating, fumigation, aroma pervasion, or packaging.

The composition of the present invention is preferably based on a methanol extract of Asarum sieboldii, or a hexane fraction, a methylene chloride fraction, or an ethyl acetate fraction from the methanol extract, more preferably on a methanol extract of Asarum sieboldii or a hexane fraction from the methanol extract. Most preferably, the composition comprises a methanol extract of Asarum sieboldii or a hexane fraction from the methanol extract at a concentration of from 0.001 to 0.008 g/ml in 70% ethanol.

The cultural properties to be conserved with the composition of the present invention may be those made of woods, paper, or fibers. More preferable are wooden cultural properties. For practical use in conserving cultural properties, the insect proofing or insecticidal composition of the present invention may be diluted to a suitable concentration. The insect proofing or insecticidal composition may be applied to cultural properties by various methods, including, but not limited to, direct spraying, coating, fumigation, aroma pervasion, and packaging with a wrapping sheet. The insect proofing or insecticidal composition of the present invention may be formulated into aerosols or liquids for direct spraying, tinctures for fumigation or aroma pervasion, or matrix gels for sustained release.

The dose at which the insect proofing or insecticidal composition is applied to cultural properties may vary depending on ingredient and application type. For example, when aroma pervasion is employed, aroma is set to pervade at a concentration of 50 ml/m³ or higher in air, and preferably at a concentration of 125 ml/m³ or higher.

While exhibiting excellent insect proofing or insecticidal activity against termites in addition to being environmentally friendly, the extract of Asarum sieboldii or an organic solvent fraction thereof in accordance with the present invention can be used to conserve wooden structures and cultural properties.

A better understanding of the present invention may be obtained through the following examples which are set forth to illustrate, but are not to be construed as limiting the present invention.

### Example 1

### Preparation of Methanol Extract of Asarum sieboldii

Asarum sieboldii was purchased from a herbal medicine shop. After removal of leaves therefrom, the plant was dried in a shady place. In a 50 L plastic vessel, 7.5 kg of the dried Asarum sieboldii was placed. The plant was immersed in 20 L of methanol at room temperature for one week, followed by filtration through a filter (Advantec No. 2). The filtrate was placed in a 2 L glass vessel and concentrated using a centrifugal vacuum concentrator (EYELA, MV-100/Japan) to remove the methanol, leaving 300 g of a methanol extract of Asarum sieboldii.

### Example 2

### Preparation of Solvent Fraction of Asarum sieboldii

In order to prepare fractions of Asarum sieboldii, fractionation was conducted on the basis of a polarity difference between solvents.

In this regard, the methanol extract of Asarum sieboldii, prepared in Example 1, was suspended in primary distilled water at a ratio of 1:1, and the suspension was mixed at a ratio of 1:1 with n-hexane in a separatory funnel (Duran 2 L). After shaking the mixture for five minutes, the upper layer was removed from the separatory funnel and concentrated using a centrifugal vacuum concentrator to remove hexane. This fractionation procedure was repeated two more times to obtain a hexane fraction. On the other hand, the lower aqueous layer was mixed at a ratio of 1:1 with primary distilled water and then at a ratio of 1:1 with methylene chloride in a separatory funnel, followed by fractionating in the same manner as for the hexane fraction, with the exception that the lower layer, instead of the upper layer, was taken from the separatory funnel. As a result, a methylene chloride fraction of Asarum sieboldii was obtained. The remaining upper layer was used to prepare an ethyl acetate fraction of Asarum sieboldii in the same manner as for the hexane fraction.

### Example 3

### Preparation of Composition Comprising an Extract of Asarum sieboldii or a Fraction Thereof as an Active Ingredient

To prepare a composition comprising an extract of Asarum sieboldii or a fraction thereof as an active ingredient, the methanol extract of Asarum sieboldii, the hexane fraction, the methylene chloride fraction and ethyl acetate fraction, prepared in Example 1 or 2, and a methylene chloride fraction from the methanol extract were diluted to a concentration of 0.001˜0.008 g/ml in 70% ethanol.

### Test Example 1

### Test of Asarum sieboldii Extract or Fraction Thereof for Insecticidal Activity

1-1 Breeding of Termites

For use as a target in which the Asarum sieboldii extract or fractions thereof were tested for insecticidal activity, termites, known to cause great damage to wooden structures and cultural properties, were gathered and bred.

In this context, Reticulitermes speratus insects were collected at Mt. Whabong, located in Doryong-Dong, Yusung-Ku, Daejeon, Korea, and bred from generation to generation. Particularly, workers, which directly damage wooden structures, were selected from the insects.

1-2 Examination of Insecticidal Activity of Asarum sieboldii Extract or Fractions Thereof

An examination was made of the insecticidal activity of an extract of Asarum sieboldii or fractions thereof. A filter paper (55 mm, Hyundai Micro) was attached to a Petri dish cover (diameter 55 mm, SPL) via a double-sided tape, soaked with 250 μL of the extract or each of the fractions prepared in Example 1 or 2 using a micropipette, and dried for 30 minutes in a shady place. In consideration of the fact that termites are reluctant to live in dry places, filter paper was placed on the bottom of the Petri dish and soaked with primary distilled water. Next, 20 worker termites were placed on the filter paper in the Petri dish which was then closed with the cover. This experiment was conducted in triplicate with 20 workers for each concentration. In addition, the extract and fractions were used at very small concentrations because a pre-test showed that termites were much more susceptible to the extract or fractions than were Lasioderma serricorne.

As can be seen in FIG. 1, the methanol extract of Asarum sieboldii did not exert significant insecticidal activity 24 and hours after application, but the insecticidal activity was found to rapidly increase 72 hours after application. Even at a concentration of 0.004 g/mL, the methanol extract guaranteed a mortality of 68.3%. A higher concentration increased the mortality to as high as 80%. In addition, the remaining individuals, although alive, were knocked out so that they could not move. Therefore, the methanol extract was proven to have excellent insecticidal activity against termites (FIG. 1).

In addition, as is apparent from the data of FIG. 2, the insecticidal activity of the hexane fraction from the methanol extract of Asarum sieboldii was potently exhibited from 24 hours after application. Mortality of as high as 80% was obtained even at a concentration of 0.005 g/mL. After 48 hours, the mortality reached nearly 100%. However, the mortality was sharply reduced to less than 40% at a concentration of 0.004 g/mL. In the insecticidal composition, therefore, a suitable concentration of the hexane fraction was found to range from 0.004 g/mL to 0.005 g/mL (FIG. 2).

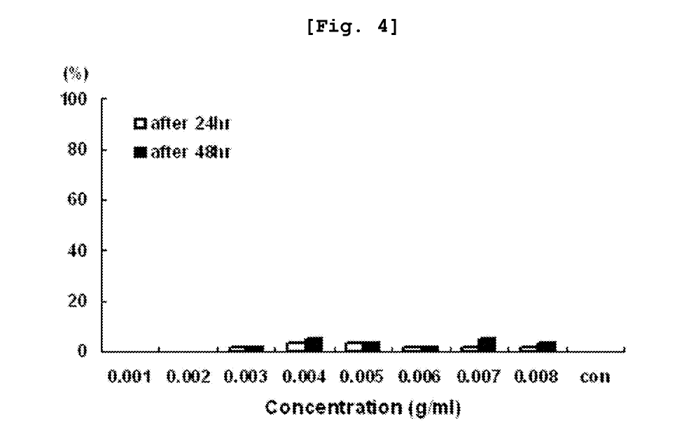

Further, as can be seen in FIGS. 3 and 4, neither the methylene chloride fraction nor the ethyl acetate fraction at all concentrations showed insecticidal activity, indicating that main insecticidal ingredients of Asarum sieboldii were fractionated into the hexane layer (FIGS. 3 and 4).

1-3 Examination of Insecticidal Activity of Methylene Chloride Fraction Obtained Directly from Methanol Extract of Asarum sieboldii

To examine whether insecticidal ingredients of Asarum sieboldii were fractionated with methylene chloride, a methylene chloride fraction was obtained directly from the methanol extract of Asarum sieboldii in a similar manner to that of Example 2 because the methylene chloride fraction obtained from the hexane fraction was found to have almost no insecticidal activity.

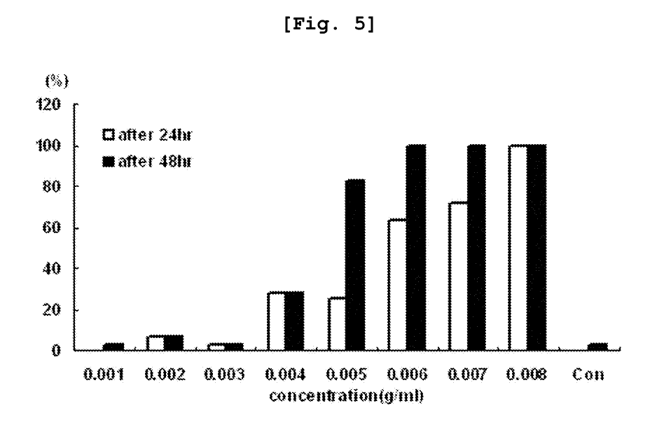

As shown in FIG. 5, the methylene chloride fraction from the methanol extract of Asarum sieboldii was found to have similar insecticidal activity to that of the hexane fraction. In addition, while the hexane fraction from the methanol extract of Asarum sieboldii, as proved in Test Example 1-2, exerted excellent insecticidal activity 24 hours after application and killed almost all subjects 48 hours after application at a concentration of 0.005 g/mL, the methylene chloride fraction from the methanol extract of Asarum sieboldii showed a mortality of 83.3% 48 hours after application at a concentration of 0.005 g/mL. Therefore, insecticidal ingredients were fractionated with methylene chloride if they did not experience hexane fractionation in advance (FIG. 5).

### Test Example 2

### Oral Toxicity Test of Asarum sieboldii

To examine the toxicity of Asarum sieboldii, it was orally administered to rats and an approximate lethal dose (LD₅₀) was determined. In this regard, an extract of Asarum sieboldii was diluted to a concentration of 0.2 g/mL in primary distilled water and assigned to Biotoxtech Co., Ltd. for toxicity assay.

2-1 Preparation of Test Substance

The test substance was weighed on an electronic scale. In a bottle, a determined amount of the test substance was mixed with a part of an additive (Choongwae Pharma Corp., Korea) using a vortex mixer and diluted to a predetermined concentration with an additive.

2-2 Preparation of Test Animal

The test substance was administered to rats (Sprague-Dawley). Rats are typically employed for safety tests of medicines, and a great deal of fundamental reference data obtained from rats has been accumulated. Twenty-six male rats weighing 90˜150 g and twenty-six female rats weighing 80˜140 g were purchased, all being five weeks old. For administration, 20 rats per sex, which were six weeks old, were selected.

2-3 Quarantine Acclimation

When brought in, the animals were weighed on an electronic scale and their appearance was examined. Then, they were acclimated for six days during which their general states were monitored once a day. On the final day of the acclimation, they were weighed again. On the basis of the data about general states and weight changes, the health states of the animals were determined. Animals which were determined to be abnormal were euthanatized with CO₂ gas.

2-4 Discriminations of Individuals and Breeding Cages

When animals were brought in, a red mark was made on their tails while individual ID cards were assigned to breeding cages during the acclimation. For a period of observation, the animals were marked on their tails with a blue oil pen and colored individual ID cards were assigned to breeding cages.

2-5 Group Division

Animals which were determined to show no abnormality in terms of general state and weight were divided into groups on the final day of the acclimation. Thirty animals that approximated the average weight were selected, and were randomly divided into six groups of five for each sex.

2-6 Administration

To examine the safety of the test substance, an oral toxicity assay was conducted. The injection volume of the test substance was set to be 10 mL/kg and calculated on the basis of the weights measured after starvation (on day of administration). The test substance was intragastrically injected once using a disposable syringe (3 mL) equipped with a sonde. All animals were starved approximately 16 hours before administration, with free access to water, and then fed food approximately four hours after administration.

TABLE 1

| | | Injection | Injection | | |
|---|---|---|---|---|---|
| | | Concentration | volume | No. of Rats | |
| Group | | (mg/kg) | (ml/kg) | Male | Female |
| G1 | Control | 0 | 10 | 5 | 5 |
| G2 | Low-Dose Group | 1000 | 10 | 5 | 5 |
| G3 | Mid-Dose Group 1 | 2000 | 10 | 5 | 5 |
| G4 | Mid-Dose Group 2 | 3000 | 10 | 5 | 5 |
| G5 | Mid-Dose Group 3 | 4000 | 10 | 5 | 5 |
| G6 | High-Dose Group | 5000 | 10 | 5 | 5 |

2-7 Observation and Examination

The animals were monitored for general states (kinds and expression time of toxicity and recovery from toxicity) and death at least once until 30 minutes after injection and at 1, 2, 4 and 6 hours after injection. From day 1 to day 14 after injection, general states were observed once a day. When discovered, dead animals were weighed and subjected to a postmortem examination. If an autopsy was not possible immediately after the discovery of dead animals, they were stored in a refrigerator for 24 hours before a postmortem examination. Weights were measured on the day of administration (before administration) and 1, 3, 7, and 14 days (the day of autopsy) after administration. Thereafter, all live animals were euthanized with CO₂ gas and forced to hemorrhage from the abdominal aorta before an autopsy. If necessary, organs which were found to be abnormal upon observation of the naked eye were subjected to histopathological examination.

2-8 Results

2-8-1 Death Case

Death cases were examined after the toxicity test of Asarum sieboldii extracts.

When the male rats were injected at a dose of 4000 mg/kg, one death case was observed 4 hours after injection and two cases one day after injection. Injection at a dose of 5000 mg/kg caused one death case six hours later. As for female rats, death occurred in one, six hours after injection at a dose of 2000 mg/kg and 4000 mg/kg, each, in two one day after injection at a dose of 3000 mg/kg, and in two one day and in one three days after injection at a dose of 5000 mg/kg.

2-8-2 General State Case

After intragastric injection of the Asarum sieboldii extract at predetermined doses, general states were monitored.

Two cases of irregular breathing were observed in each of the male and female groups six hours after injection at a dose of 1000 mg/kg, but no abnormalities were detected from one day after injection.

In a male group injected at a dose of 2000 mg/kg, five animals suffered from irregular breathing, lacrimation, or salivation on the day of injection. One day after the injection, three irregular breath cases were observed, but disappeared from day 2 two. In the female group, salivation, tremor, irregular breathing, a decrease in locomotor activity, or lacrimation was observed on the day of injection, with the occurrence of one death case in a prone position six hours after injection. One day after injection, four irregular breathing cases were detected while one rat suffered from a decrease of fecal volume. From day 2, no abnormal general states were detected. Before death in a prone position, the animal suffered from irregular breathing, salivation, tremors, a decrease in locomotor activity, or lacrimation from two to six hours after injection.

Five cases of irregular breathing, lacrimation, salivation, a decrease in locomotor activity, or tremors were observed in each of the male and female groups on the day of injection at a dose of 3000 mg/kg. Four cases of irregular breathing and one case each of a decrease in feed intake, a decrease in locomotor activity, a decrease of fecal volume, salivation, and contamination of the lower abdomen were observed one day after the injection. Two cases of irregular breathing were detected two days after the injection, but no abnormal general states were observed from day 3. In the female group, irregular breathing, a decrease of fecal volume, contamination in the lower abdomen, a decrease in food intake, a decrease in locomotor activity, lacrimation, or contamination around the mouth was observed. One day after the injection, two rats suffered from lacrimation and salivation before death in a recumbent position.

In the male and female groups injected at a dose of 4000 mg/kg, irregular breathing, lacrimation, salivation, a decrease in locomotor activity, or tremors was observed on the day of injection. One and two days after the injection, irregular breathing, a decrease in food intake, or a decrease in fecal volume was observed. From day 3, no abnormalities of general states were detected. Irregular breathing, lacrimation, salivation, a decrease in locomotor activity, tremors, or prone positioning was observed in two rats which died four and six hours after the injection, respectively. One day after the injection, two rats suffered lacrimation and salivation before death in a prone position.

In the male and female group injected at a dose of 5000 mg/kg, irregular breathing, lacrimation, salivation, a decrease in locomotor activity, or tremors was observed on the day of injection. From day 1 to day 5 after injection, the rats suffered from irregular breathing, a decrease in food intake, a decrease in fecal volume, or contamination in the lower abdomen or around the mouth. However, no abnormalities of general states were detected from day 6 after the injection. One male rat suffered from irregular breathing, lacrimation, or salivation before death in a prone position six hours after the injection. One day after the injection, one female rat suffered from lacrimation and died in a prone position. After the observation of a decrease in food intake, a decrease of fecal volume, lacrimation, salivation, or a decrease in locomotor activity, one rat died in a recumbent position with contamination in the lower abdomen or around the mouth.

2-8-3 Change in Weight

The extract of Asarum sieboldii was orally administered at predetermined doses, after which weight was monitored.

As can be seen in FIGS. 6 and 7, a significant decrease of weight was found in the male groups one and three days after injection with 3000 and 5000 mg/kg, compared to the control. In contrast, no significant changes of weight were found in the female groups, compared to the control (FIGS. 6 and 7).

2-8-4 Autopsy Findings

Animals which survived the predetermined doses of Asarum sieboldii were subjected to a post-mortem examination. No abnormal findings were observed with the naked eye in both the male and female groups. In one female rat, which died due to injection of the extract at a dose of 5000 mg/kg, a dark lesion was observed on the proventriculus.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for destroying termites, comprising treating the termites with an extract of Asarum sieboldii or organic solvent fraction from the extract.

2. The method of claim 1, wherein the termites belong to Reticultitermes speratus or R. speratus kyushuensis Morimoto.

3. The method of claim 1, wherein the termites belong to Reticultitermes speratus.

4. The method of claim 1, wherein the extract of Asarum sieboldii is prepared using methanol, ethanol, water or a mixture thereof.

5. The method of claim 1, wherein the extract of Asarum sieboldii is prepared by extracting Asarum sieboldii with methanol.

6. The method of claim 1, wherein the organic solvent fraction is a hexane fraction.

7. The method of claim 1, wherein the treating comprises treating the termites with the extract of Asarum sieboldii or organic solvent fraction from the extract by direct spraying, coating, fumigation, aroma pervasion or packaging.

8. A method for repelling termites, comprising treating the termites with an extract of Asarum sieboldii or organic solvent fraction from the extract.

9. The method of claim 8, wherein the termites belong to Reticultitermes speratus or R. speratus kyushuensis Morimoto.

10. The method of claim 8, wherein the termites belong to Reticultitermes speratus.

11. The method of claim 8, wherein the extract of Asarum sieboldii is prepared using methanol, ethanol, water or a mixture thereof.

12. The method of claim 8, wherein the extract of Asarum sieboldii is prepared by extracting Asarum sieboldii with methanol.

13. The method of claim 8, wherein the organic solvent fraction is a hexane fraction.

14. The method of claim 8, wherein the treating comprises treating the termites with the extract of Asarum sieboldii or organic solvent fraction from the extract by direct spraying, coating, fumigation, aroma pervasion or packaging.

15. A method for conserving cultural properties, comprising treating the cultural properties with an extract of Asarum sieboldii or organic solvent fraction from the extract.

16. The method of claim 15, wherein the treating comprises treating the termites with the extract of Asarum sieboldii or organic solvent fraction from the extract by direct spraying, coating, fumigation, aroma pervasion or packaging.

17. The method of claim 15, wherein the cultural properties are made of an organic material.

18. The method of claim 17, wherein the organic material is a wood, a paper, or a fiber.
